(19) United States
(12) Patent Application Publication
(10) Pub. No.: US 2025/0078082 A1
(43) Pub. Date: Mar. 6, 2025

(54) DATA CUBE SYSTEMS AND METHODS FOR DYNAMIC RULE CREATION

(71) Applicant: MASTERCARD INTERNATIONAL INCORPORATED, Purchase, NY (US)

(72) Inventor: John Eck, St. Louis, MO (US)

(21) Appl. No.: 18/458,782

(22) Filed: Aug. 30, 2023

(51) Int. Cl. G06Q 20/40; G06F 16/2455; G06F 16/28

(52) U.S. Cl. CPC G06Q 20/4016; G06F 16/24564; G06F 16/283

(57) ABSTRACT

A dynamic rule query system is provided. The dynamic rule query system includes a memory device and at least one processor. The at least one processor is programmed to store a plurality of information in a data cube, receive a selection of one or more rules and one or more data elements of the data cube, generate a DAX (data analysis expressions) query based upon the one or more rules and the one or more elements of the data cube, execute the DAX query on the data cube to receive results, and analyze the results to determine whether or not to activate one or more alerts.

### BACKGROUND

The present application relates generally to a data cube for dynamic rule creation, and more particularly, to computer based systems and methods for managing rule queries for querying a data cube.

A data cube (or datacube) is a multi-dimensional (“n-D”) array of values. The data cube is used to represent data along some dimensions of interest. Even though it is called a cube, a data cube generally is a multi-dimensional concept which can be 1-dimensional, 2-dimensional, 3-dimensional, or higher-dimensional. Every dimension divides data into groups of cells whereas each cell in the cube represents a single measure of interest. These data cubes may contain millions or even billions of records.

Systems that analyze these records may use hundreds of queries and dataflows to detect patterns in the records and lack flexibility. These records may be stored in multiple different tables, which can mean that there are different measures, metrics, labels, and parameters along with different join operations. While these records may be stored in one or more data cubes, to analyze billions of transactions the preset queries may oftentimes take up to six to twelve hours to process.

These limitations in these known query processing systems further complicate matters when trying to perform dynamic query building. Furthermore, the need to create a new rule or expand the coverage of the current rules for these systems requires modifications to the underlying software to implement the new rule or expand the current coverage of existing rules. The code to accomplish the creation of the new rule or modification of an existing rule within these systems is significantly complicated and difficult to maintain due to the size and complexity of the systems. Accordingly, it would be useful to simplify the querying processing systems to reduce the complexity of updates.

### BRIEF DESCRIPTION

In one aspect, a dynamic rule query system is provided. The dynamic rule query system includes a memory device and at least one processor coupled to the memory device. The at least one processor is programmed to store a plurality of information in a data cube. The at least one processor is also programmed to receive a selection of one or more rules and one or more data elements of the data cube. The at least one processor is further programmed to generate a DAX (data analysis expressions) query based upon the one or more rules and the one or more elements of the data cube. In addition, the at least one processor is programmed to execute the DAX query on the data cube to receive results. Furthermore, the at least one processor is programmed to analyze the results to determine whether or not to activate one or more alerts.

In another aspect, a computer-implemented method for dynamic rules queries is provided. The method is implemented on a computing device comprising a memory device coupled to at least one processor. The method includes storing a plurality of information in a data cube. The method also includes receiving a selection of one or more rules and one or more data elements of the data cube. The method further includes generating a DAX (data analysis expressions) query based upon the one or more rules and the one or more elements of the data cube. In addition, the method includes executing the DAX query on the data cube to receive results. Furthermore, the method includes analyzing the results to determine whether or not to activate one or more alerts.

In a further aspect, at least one non-transitory computer-readable storage media having computer-executable instructions embodied thereon for authenticating an online user is provided. When executed by at least one processor, the computer-executable instructions cause the at least one processor to store a plurality of information in a data cube. The computer-executable instructions also cause the at least one processor to receive a selection of one or more rules and one or more data elements of the data cube. The computer-executable instructions further cause the at least one processor to generate a DAX (data analysis expressions) query based upon the one or more rules and the one or more elements of the data cube. In addition, the computer-executable instructions cause the at least one processor to execute the DAX query on the data cube to receive results. Furthermore, the computer-executable instructions analyze the results to determine whether or not to activate one or more alerts.

### BRIEF DESCRIPTION OF THE DRAWINGS

FIGS. 1-7 show example embodiments of the methods and systems described herein.

FIG. 1 is a schematic diagram illustrating an example dynamic rule query (DRQ) platform in communication with a multi-party payment processing system for processing transactions in accordance with one embodiment of the present disclosure.

FIG. 2 is an expanded block diagram of an example embodiment of a computer system used for dynamic rule queries.

FIG. 3 illustrates a flow diagram of an example process of analyzing data using DAX queries implemented using the system shown in FIG. 2.

FIG. 4 illustrates an example configuration of a user computing device.

FIG. 5 illustrates an example configuration of a server system, such as the dynamic rule query (DRQ) platform shown in FIG. 1, in accordance with one example embodiment of the present disclosure.

FIG. 6 is a flow diagram of an example process for dynamic rule queries using the DRQ system shown in FIG. 2.

FIG. 7 illustrates a sample data cube as shown in FIG. 3.

Although specific features of various embodiments may be shown in some drawings and not in others, this is for convenience only. Any feature of any drawing may be referenced and/or claimed in combination with any feature of any other drawing.

### DETAILED DESCRIPTION

The systems and methods described herein relate generally to dynamically managing rule queries for querying a data cube. The systems and methods described herein recite a dynamic rule query system, which allows users to update existing queries and generate new queries without requiring significant reprogramming of the queries and/or significant programming knowledge.

By way of example and not by way of limitation, one embodiment of the systems and methods described herein includes using a data cube and a dynamic managing rule query system for managing queries to detect patterns in large collections of records (e.g., millions to billions of records). The system may be configured to use a plurality of different information (such as records) that can be used as input to different queries for viewing potential patterns in that information. These patterns may change over time as new methods and indicators are discovered. Furthermore, the patterns may also change as the user attempts to discover other issues. Accordingly, the dynamic rule query system described herein recites an efficient methodology for updating such rule queries to keep the query systems up to date and flexible.

In the exemplary embodiment, data from a plurality of databases are used to populate a data cube. The data cube (or datacube) is a multi-dimensional (“n-D”) array of values. The data cube is used to represent data along some dimensions of interest. Even though it is called a cube, a data cube generally is a multi-dimensional concept which can be 1-dimensional, 2-dimensional, 3-dimensional, or higher-dimensional. Every dimension divides data into groups of cells whereas each cell in the cube represents a single measure of interest. In at least one embodiment, the records from a plurality of databases are concatenated together to populate the data cube. The dynamic rule query system may add additional fields to assist with consolidating columns from different databases.

In the exemplary embodiment, the data cube simplifies having to analyze multiple tables where data fields may have different column names. In some embodiments, different tables may have different names for the same entity, even including slight variations, which may cause problems in querying the tables. In some situations, in the databases, there may be up to four different names for the same party from different tables, based on how the party was set-up in the table.

In the exemplary embodiment, a plurality of rules and elements are available for use with the dynamic rule query system. In the dynamic rule query system, the DAX (data analysis expressions) queries are configured to have a plurality of fields or elements which are set-up based upon the needs of the user and how the data cube is set-up. In the exemplary embodiment, the multiple element configuration of the data cube and DAX queries allows for users to update DAX queries by changing one or more elements without having to significantly reprogram the dynamic rule query system since the options are based on the configuration and build of the data cube.

In some embodiments, the data cube may have one or more joins with one or more additional tables. While normal queries would support a single join, the dynamic rule query system uses DAX (data analysis expressions) queries. Data Analysis Expressions (DAX) is a formula expression language. DAX formulas include functions, operators, and values to perform advanced calculations and queries on data in related tables and columns in tabular data models. The use of DAX queries allows for the user to define one or more secondary joins. When executed, the DAX query may use the different relationships. A DAX query could be generated for each of the join-based relationships with only a single element changing between the queries.

The DAX query includes rules and elements selected by the user. The dynamic rule query allows the user to configure the rules to exactly manipulate the data in the data cube based on the results that the user is looking for. A rule can be configured to be built over calculations. For example, a rule could include filtering the data, then filtering down the results, then removing part of the filter, then do a separate calculation on those results and then to a comparison. Based on the configuration of the data cube, the DAX query allows for a plurality of filters that can be dynamically added and removed. In the exemplary embodiment, the rules include a plurality of predefined rules that the user may select from in different combinations. In at least one embodiment, each rule includes a listing of the different table columns that the rule summarizes.

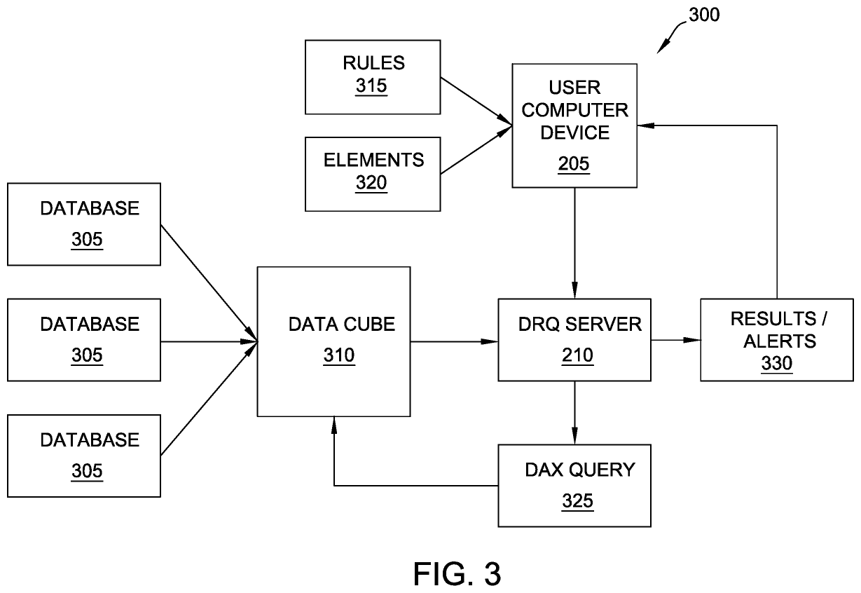

The elements are also selectable by the user. The elements 320 (shown in FIG. 3) include one or more fields that the DAX query may manipulate, retrieve, and/or filter on. In an example embodiment, there may be three elements that make up a DAX query in addition to the rules. The rules are a combination of filters, comparisons, and calculations that are performed on the transactions. In at least one embodiment, the rule is configured to trigger one or more alerts based on the results. The first element could have two options. The second element could have four options. And the third element could have twelve options. The DAX query may be set-up with selected options for each of the second through fourth elements.

In at least one embodiment, the combinations of elements and rules can provide a large plurality of DAX queries that can be executed. In one embodiment, there may be 496 different DAX queries that can be run on a single data cube. The DAX queries are configured to execute quickly on the data cube and are capable of analyzing billions of records.

In the exemplary embodiment, the DAX query pulls the data in, aggregates it, performs all of the calculations and filtering in the rule, and then determines if there is an alert based on the results. The alert may be based on one or more thresholds being exceeded. In some embodiments, the dynamic rule query system includes a plurality of predetermined rules and the DAX query is instructed which of the predetermined rules to execute on the data.

One potential, non-limiting use for the dynamic rule query system is for detecting patterns in payment transactions that may be indicative of money laundering. For the anti-money laundering implementation, the data cube includes a combination of both clearing and debit transactions. These transactions may include both credit and debit transactions that are processed over a payment network, sometimes referred to as an interchange network or other payment processing network. In the case of clearing transactions, this refers to credit transactions that may include separate messages for authorization, clearing and settlement. In the case of debit transactions, this refers to debit transactions that may include a single message for authorization, clearing and settlement. In at least one embodiment, a new network field is added to the data cube to indicate whether the transaction is a clearing or debit transaction.

Another issue for the anti-money laundering implementation is that there may be up to six different types of parties involved in processing the transactions, these include, but are not limited to, an issuing bank, an acquiring bank, a digital wallet operator, a payment facilitator, an issuing CGI, an Automated Clearing House (ACH), an account-to-account transaction processors (i.e., Apple Pay® environment (Apply Pay is a registered trademark of Apple Inc. located in Cupertino, CA)), and/or an acquiring CGI. A digital wallet operator stores one or more payment cards and submits the desired account when needed. A payment facilitator is a merchant services business that sets up electronic payment and processing services for business owners, so they can accept electronic payments online or in-person. CGI represent large government and institutional banks. All of these parties may be stored in multiple different tables and be completely separate dimensions. These parties would also require multiple joins in a regular table set-up.

In the anti-money laundering implementation of the dynamic rule query system, the dynamic rule query system generates a data cube combining the transactions where a party is the acquirer and where the party is the issuer in the transactions. The dynamic rule query system adds a field to indicate whether or not the party is a CGI. This data cube simplifies having to analyze multiple tables where data fields may have different column names. In some embodiments, different tables may have different names for the same entity, even including slight variations, which may cause problems in querying the tables. In some situations, there may be up to four different names for the same party from different tables, based on how the party was set-up in the table.

In the anti-money laundering implementation of the dynamic rule query system, the table containing all of the transactions has a plurality of joins with a customer table. While normal queries would support a single join, the dynamic rule query system uses DAX queries. The use of DAX queries allows for the user to define one or more secondary joins. When executed, the DAX query may use the different relationships. For example, the primary join between the transaction table and the customer table could be for the issuing customer (e.g., issuing bank). The secondary joins could then be the acquiring customer (e.g., acquiring bank), the digital wallet, and/or the payment facilitator. The same DAX query could be generated for each of the four customer types with only the customer type changing between the queries.

In the anti-money laundering implementation, there are four elements that make up a rule. The first element is the rule itself. The rule is the combination of filters, comparisons, and calculations that are performed on the transactions. In at least one embodiment, the rule is configured to trigger one or more alerts based on the results. The second element is the network, either clearing or debit. The third element is the customer type, one of the four of issuing customer, acquiring customer, the digital wallet, and/or the payment facilitator. The fourth element is the permutation of transaction type. Examples of this include, but are not limited to, ATM, prepaid card, ATM prepaid, card-not-present, POS e-commerce, and/or e-commerce. The DAX query may be set-up for one or more of each of the second through fourth elements.

While the above describes the dynamic rule query system being used for an anti-money laundering implementation, one having skill in the art would understand that other implementations may be used as well. For a non-limited example, the dynamic rule query system may be used to analyze cryptographic transactions and/or analyze transactions to determine one or more other trends and/or patterns. The systems could also be used for analyzing other data stored within a data cube; data that is not necessarily related to money laundering or even financial transactions. The system should not be limited to such applications.

At least one of the technical problems addressed by this system includes: (i) increased accuracy of analysis of large amounts of data; (ii) reduced errors from differences in table set-up; (iii) reduced required computer processing resources in analyzing large amounts of data; and (iv) decreased complexity in analyzing significant amounts of data.

A technical effect of the systems and processes described herein is achieved by performing at least one of the following steps: a) store a plurality of information in a data cube, wherein the data cube includes a concatenation of data from a plurality of tables; b) receive a selection of one or more rules and one or more data elements of the data cube, wherein the one or more data elements are selected from a plurality of data elements of the data cube, wherein the one or more rules are selected from a plurality of rules; c) generate a DAX (data analysis expressions) query based upon the one or more rules and the one or more elements of the data cube; d) execute the DAX query on the data cube to receive results; e) analyze the results to determine whether or not to activate one or more alerts; f) wherein the DAX query analyzes the results to determine whether or not to active the one or more alerts; g) wherein the one or more alerts are activated when the results exceed one or more predetermined thresholds; h) wherein the data cube includes a plurality of payment transactions including both credit and debit transactions; i) wherein the DAX query is configured to determine if one or more patterns are present in the data in the data cube; j) wherein the one or more patterns indicate the potential presence of money laundering activity; and k) wherein the potential presence of money laundering activity is at an issuer bank associated with a plurality of transactions in the data cube.

As will be appreciated, based on the description herein the technical improvement in the dynamic rule system as described herein is a computer-based solution to a technical deficiency or problem that is itself rooted in computer technology (e.g., the problem itself derives from the use of computer technology). More specifically, data analysis systems require tremendous amounts of resources when analyzing large amounts of data. Dynamic Rule Query methodologies (e.g., DRQ) are useful to more efficiently process and analyze transactions and messages in an efficient manner and significantly reduce the computer processing resources required to analyze large amounts of data. Accordingly, to address this problem, the systems and methods described herein address this technical problem by using a dynamic rule query (DRQ) server and DRQ engine to analyze large amounts of data in reduced time.

The following detailed description of the embodiments of the disclosure refers to the accompanying drawings. The same reference numbers in different drawings may identify the same or similar elements. Also, the following detailed description does not limit the claims.

Described herein are computer systems such as authentication computer systems. As described herein, all such computer systems include a processor and a memory. However, any processor in a computer device referred to herein may also refer to one or more processors wherein the processor may be in one computing device or a plurality of computing devices acting in parallel. Additionally, any memory in a computer device referred to herein may also refer to one or more memories wherein the memories may be in one computing device or a plurality of computing devices acting in parallel.

As used herein, a processor may include any programmable system including systems using micro-controllers, reduced instruction set circuits (RISC), application specific integrated circuits (ASICs), logic circuits, and any other circuit or processor capable of executing the functions described herein. The above examples are example only, and are thus not intended to limit in any way the definition and/or meaning of the term “processor.”

As used herein, the term “database” may refer to either a body of data, a relational database management system (RDBMS), or to both. As used herein, a database may include any collection of data including hierarchical databases, relational databases, flat file databases, object-relational databases, object oriented databases, and any other structured collection of records or data that is stored in a computer system. The above examples are example only, and thus are not intended to limit in any way the definition and/or meaning of the term database. Examples of RDBMS's include, but are not limited to including, Oracle® Database, MySQL, IBM® DB2, Microsoft® SQL Server, Sybase®, and PostgreSQL. However, any database may be used that enables the systems and methods described herein. (Oracle is a registered trademark of Oracle Corporation, Redwood Shores, California; IBM is a registered trademark of International Business Machines Corporation, Armonk, New York; Microsoft is a registered trademark of Microsoft Corporation, Redmond, Washington; and Sybase is a registered trademark of Sybase, Dublin, California.)

In one embodiment, a computer program is provided, and the program is embodied on a computer readable medium. In an example embodiment, the system is executed on a single computer system, without requiring a connection to a sever computer. In a further embodiment, the system is being run in a Windows® environment (Windows is a registered trademark of Microsoft Corporation, Redmond, Washington). In yet another embodiment, the system is run on a mainframe environment and a UNIX® server environment (UNIX is a registered trademark of X/Open Company Limited located in Reading. Berkshire, United Kingdom). In a further embodiment, the system is run on an iOS® environment (iOS is a registered trademark of Cisco Systems, Inc. located in San Jose, CA). In yet a further embodiment, the system is run on a Mac OS® environment (Mac OS is a registered trademark of Apple Inc. located in Cupertino, CA). In still yet a further embodiment, the system is run on Android® OS (Android is a registered trademark of Google, Inc. of Mountain View, CA). In another embodiment, the system is run on Linux® OS (Linux is a registered trademark of Linus Torvalds of Boston, MA). The application is flexible and designed to run in various different environments without compromising any major functionality. In some embodiments, the system includes multiple components distributed among a plurality of computing devices. One or more components may be in the form of computer-executable instructions embodied in a computer-readable medium.

As used herein, an element or step recited in the singular and proceeded with the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional embodiments that also incorporate the recited features.

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are example only, and are thus not limiting as to the types of memory usable for storage of a computer program.

Furthermore, as used herein, the term “real-time” refers to at least one of the time of occurrence of the associated events, the time of measurement and collection of predetermined data, the time for a computing device (e.g., a processor) to process the data, and the time of a system response to the events and the environment. In the embodiments described herein, these activities and events may be considered to occur substantially instantaneously.

As used herein, the terms “payment device,” “transaction card,” “financial transaction card,” and “payment card” refer to any suitable transaction card, such as a credit card, a debit card, a prepaid card, a charge card, a membership card, a promotional card, a frequent flyer card, an identification card, a prepaid card, a gift card, and/or any other device that may hold payment account information, such as mobile phones, Smartphones, personal digital assistants (PDAs), wearable computing devices, key fobs, and/or any other computing devices capable of providing account information. Moreover, these terms may refer to payments made directly from or using bank accounts, stored valued accounts, mobile wallets, etc., and accordingly are not limited to physical devices but rather refer generally to payment credentials. Each type of payment device can be used as a method of payment for performing a transaction. In addition, consumer card account behavior can include but is not limited to purchases, management activities (e.g., balance checking), bill payments, achievement of targets (meeting account balance goals, paying bills on time), and/or product registrations (e.g., mobile application downloads).

The systems and processes are not limited to the specific embodiments described herein. In addition, components of each system and each process can be practiced independent and separate from other components and processes described herein. Each component and process also can be used in combination with other assembly packages and processes.

The following detailed description illustrates embodiments of the disclosure by way of example and not by way of limitation. It is contemplated that the disclosure has general application to authenticating users for transactions conducted over an electronic payment network.

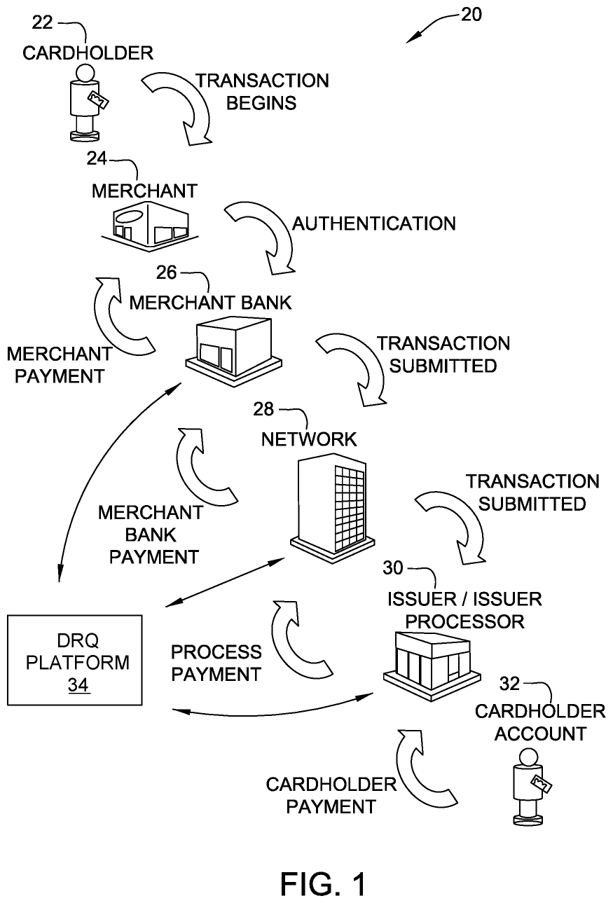

FIG. 1 is a schematic diagram illustrating an example dynamic rule query (DRQ) platform 34 in communication with a multi-party payment processing system 20 for processing transactions in accordance with one embodiment of the present disclosure. FIG. 1 depicts a flow of data for a financial transaction through system 20. Embodiments described herein may relate to a transaction card system, such as a credit card payment system using the MASTERCARD® interchange network. The MASTERCARD® interchange network is a set of proprietary communications standards promulgated by Mastercard International Incorporated® for the exchange of financial transaction data and the settlement of funds between financial institutions that are members of Mastercard International Incorporated®. (MASTERCARD® is a registered trademark of Mastercard International Incorporated located in Purchase, New York).

In the exemplary transaction card system, a financial institution called the “issuer” issues a transaction card, such as a credit card, to a consumer or cardholder 22, who uses the transaction card to tender payment for a purchase from a merchant 24. Cardholder 22 may purchase goods and services (“products”) at merchant 24. Cardholder 22 may make such purchases using virtual forms of the transaction card and, more specifically, by providing data related to the transaction card (e.g., the transaction card number, expiration date, associated postal code, and security code) to initiate transactions. To accept payment with the transaction card or virtual forms of the transaction card, merchant 24 must normally establish an account with a financial institution that is part of the financial payment system. This financial institution is usually called the “merchant bank,” the “acquiring bank,” or the “acquirer.” When cardholder 22 tenders payment for a purchase with a transaction card or virtual transaction card, merchant 24 requests authentication of the cardholder 22 and authorization from a merchant bank 26 for the amount of the purchase. The request may be performed over the telephone or electronically, but is usually performed through the use of a point-of-sale terminal, which reads cardholder's 22 account information from a magnetic stripe, a chip, or embossed characters on the transaction card and communicates electronically with the transaction processing computers of merchant bank 26. Merchant 24 receives cardholder's 22 account information as provided by cardholder 22. Alternatively, merchant bank 26 may authorize a third party to perform transaction processing on its behalf. In this case, the point-of-sale terminal will be configured to communicate with the third party. Such a third party is usually called a “merchant processor,” an “acquiring processor,” or a “third party processor.”

Using an interchange network 28, computers of merchant bank 26 or merchant processor will communicate with computers of an issuer bank 30 to determine whether the alleged cardholder is actually legitimate cardholder 22 (i.e., authentication), whether cardholder's 22 account 32 is in good standing, and whether the purchase is covered by cardholder's 22 available credit line. Based on these determinations, the requests for authentication and authorization will be declined or accepted. Authentication may be performed prior to authorization. If the requests are accepted, an authorization code is issued to merchant 24.

In the exemplary embodiment, the payment card system 20 includes or is in communication with a dynamic rule query (DRQ) server 34. In this embodiment, the DRQ platform 34 provides enhanced analysis of transactions, where the analysis is enhanced using the dynamic rule query described herein. The DRQ platform 34 uses historical transactions (credit and/or debit) to build a data cube of transactions. In the exemplary embodiment, the DRQ platform 34 receives historical data from one or more of the acquirer bank 26, the interchange network 28, and the issuer 30. The historical data may include messages and/or transaction data associated with a plurality of PANs, other historical data associated with the plurality of PANs, etc. The historical data may be associated with both card present and card not present historical transactions. For example, the historical data may include cardholder shipping address, cardholder billing address, cardholder email address, cardholder phone number, merchant name, merchant category, merchant location, and/or at least one environment-related variable (e.g., device details, browser details) including device ID, IP address, device channel, etc. Further, the historical data may be stored in a database accessible by DRQ platform 34 and operated by an interchange network 28. In some embodiments, the historical data will be hashed prior to storing to protect the security of this personally identifiable information.

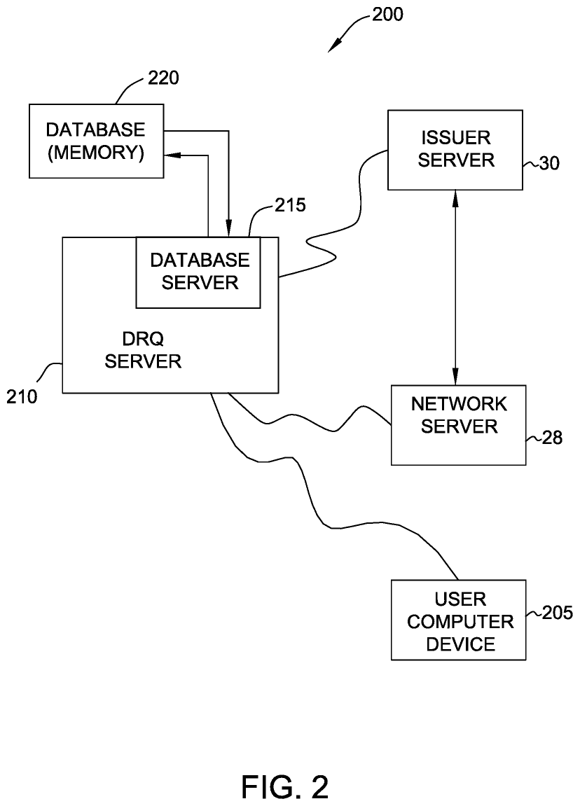

When a request for authorization is accepted, the available credit line of cardholder's 22 account 32 is decreased. Normally, a charge for a payment card transaction is not posted immediately to cardholder's 22 account 32 because bankcard associations, such as Mastercard International Incorporated®, have promulgated rules that do not allow merchant 24 to charge, or “capture,” a transaction until products are shipped or services are delivered. However, with respect to at least some debit card transactions, a charge may be posted at the time of the transaction. When merchant 24 ships or delivers the products or services, merchant 24 captures the transaction by, for example, appropriate data entry procedures on the point-of-sale terminal. This may include bundling of approved transactions daily for standard retail purchases. If cardholder 22 cancels a transaction before it is captured, a “void” is generated. If cardholder 22 returns products after the transaction has been captured, a “credit” is generated. Interchange network 28 and/or issuer bank 30 stores the transaction card information, such as a type of merchant, amount of purchase, date of purchase, in a database 120 (shown in FIG. 2).

After a purchase has been made, a clearing process occurs to transfer additional transaction data related to the purchase among the parties to the transaction, such as merchant bank 26, interchange network 28, and issuer bank 30. More specifically, during and/or after the clearing process, additional data, such as a time of purchase, a merchant name, a type of merchant, purchase information, cardholder account information, a type of transaction, information regarding the purchased item and/or service, and/or other suitable information, is associated with a transaction and transmitted between parties to the transaction as transaction data, and may be stored by any of the parties to the transaction. After a transaction is authorized and cleared, the transaction is settled among merchant 24, merchant bank 26, and issuer bank 30. Settlement refers to the transfer of financial data or funds among merchant's 24 account, merchant bank 26, and issuer bank 30 related to the transaction. Usually, transactions are captured and accumulated into a “batch,” which is settled as a group. More specifically, a transaction may be settled between issuer bank 30 and interchange network 28, and then between interchange network 28 and merchant bank 26, and then between merchant bank 26 and merchant 24.

As described below in more detail, dynamic rule query (DRQ) analysis may be performed by the DRQ platform 34 in the context of multi-party payment card system 20. Although the systems described herein are not intended to be limited to facilitate such applications, the systems are described as such for example purposes.

FIG. 2 is an expanded block diagram of an example embodiment of a computer system 200 used for dynamic rule queries. In the exemplary embodiment, system 200 may be used for performing analysis of data using dynamic rule queries as described herein. In at least one embodiment, the system 200 may be used for detecting money laundering. In at least one embodiment, system 200 is in communication with processing system 20 (shown in FIG. 1). In additional embodiments, system 200 is a part of processing system 20.

In the exemplary embodiment, user computer devices 205 are computers that include a web browser or a software application, which enables user computer devices 205 to access remote computer devices, such as DRQ server 210, using the Internet or other network. More specifically, user computer devices 205 may be communicatively coupled to the Internet through many interfaces including, but not limited to, at least one of a network, such as the Internet, a local area network (LAN), a wide area network (WAN), or an integrated services digital network (ISDN), a dial-up-connection, a digital subscriber line (DSL), a cellular phone connection, and a cable modem. User computer devices 205 may be any device capable of accessing the Internet including, but not limited to, a desktop computer, a laptop computer, a personal digital assistant (PDA), a cellular phone, a smartphone, a tablet, a phablet, wearable electronics, smart watch, or other web-based connectable equipment or mobile devices.

In the exemplary embodiment, network server 28 is a computer system used for processing of payment transaction in system 20 (shown in FIG. 1). Network server 28 includes a web browser or a software application, which enables network server 28 to access remote computer devices, such as DRQ server 210, using the Internet or other network. More specifically, network server 28 may be hosted on one or more computers that are communicatively coupled to the Internet through many interfaces including, but not limited to, at least one of a network, such as the Internet, a local area network (LAN), a wide area network (WAN), or an integrated services digital network (ISDN), a dial-up-connection, a digital subscriber line (DSL), a cellular phone connection, and a cable modem. Network server 28 may be any device capable of accessing the Internet including, but not limited to, a desktop computer, a laptop computer, a personal digital assistant (PDA), a cellular phone, a smartphone, a tablet, a phablet, wearable electronics, smart watch, or other web-based connectable equipment or mobile devices.

In the exemplary embodiment, issuer server 30 is a computer system used for processing of payment transaction in system 20. Issuer server 30 includes a web browser or a software application, which enables issuer server 30 to access remote computer devices, such as DRQ server 210, using the Internet or other network. More specifically, issuer server 30 may be hosted on one or more computers that are communicatively coupled to the Internet through many interfaces including, but not limited to, at least one of a network, such as the Internet, a local area network (LAN), a wide area network (WAN), or an integrated services digital network (ISDN), a dial-up-connection, a digital subscriber line (DSL), a cellular phone connection, and a cable modem. Issuer server 30 may be any device capable of accessing the Internet including, but not limited to, a desktop computer, a laptop computer, a personal digital assistant (PDA), a cellular phone, a smartphone, a tablet, a phablet, wearable electronics, smart watch, or other web-based connectable equipment or mobile devices.

In the exemplary embodiments, dynamic rule query (DRQ) server 210 analyzes data using dynamic rule queries, such as data from system 20. In some embodiments, the DRQ server 210 is in communication with one or more user computer devices 205. In some embodiments, DRQ server 210 is associated with system 20. In other embodiments, the DRQ server 210 is separate from system 20. In some embodiments, DRQ server 210 is similar to DRQ platform 34 (shown in FIG. 1). In the exemplary embodiment, DRQ server 210 receives elements 320 and rules 315 (both shown in FIG. 3) from a user computer device 205. The DRQ server 210 generates one or more DAX queries 325 (shown in FIG. 3) using the provided elements 320 and rules 315. The DRQ server 210 executes the one or more DAX queries 325 on a data cube 310 to receive results 330 (shown in FIG. 3) as described further herein.

In the exemplary embodiments, DRQ server(s) 210 are computers that include a web browser or a software application, which allow for communication with a plurality of user computer devices 205, using the Internet or other network. More specifically, DRQ servers 210 may be communicatively coupled to the Internet through many interfaces including, but not limited to, at least one of a network, such as the Internet, a local area network (LAN), a wide area network (WAN), or an integrated services digital network (ISDN), a dial-up-connection, a digital subscriber line (DSL), a cellular phone connection, and a cable modem. DRQ servers 210 may be any device capable of accessing the Internet including, but not limited to, a desktop computer, a laptop computer, a personal digital assistant (PDA), a cellular phone, a smartphone, a tablet, a phablet, wearable electronics, smart watch, or other web-based connectable equipment or mobile devices.

A database server 215 is connected to database 220. In one embodiment, centralized database 220 is stored on the DRQ server 210 and can be accessed by potential users at one of user computing devices 205 by logging onto DRQ server 210 through one or more client systems. In an alternative embodiment, database 220 is stored remotely from DRQ server 210 and may be non-centralized. Database 220 may be a database configured to store information in one or more data cubes 310 including, for example, historical transaction data, including both credit and debit transactions. Database 220 may also store rules 315 and elements 320 that may be used in DAX queries 325.

Database 220 may include a single database having separated sections or partitions, or may include multiple databases, each being separate from each other. Database 220 may store transaction data generated over a computer network, such as the processing system 20 including data relating to merchants, consumers, account holders, prospective customers, issuers, acquirers, and/or purchases made.

FIG. 3 illustrates a flow diagram of an example process 300 of analyzing data using DAX queries 325 implemented using the system 200 (shown in FIG. 2). In the exemplary embodiment, process 300 may be used for analyzing transactions to detect money laundering.

In the exemplary embodiment, data from a plurality of databases 305 are used to populate a data cube 310. For example, in the anti-money laundering implementation, data from a first database 305 may include credit transactions, which is concatenated with debit transactions from a second database 305. In the exemplary embodiment, database 305 is similar to database 220 (shown in FIG. 1).

The data cube 310 (or datacube 310) is a multi-dimensional (“n-D”) array of values. The data cube 310 is used to represent data along some dimensions of interest. Even though it is called a cube, a data cube 310 generally is a multi-dimensional concept which can be 1-dimensional, 2-dimensional, 3-dimensional, or higher-dimensional. Every dimension divides data into groups of cells whereas each cell in the cube represents a single measure of interest. For the anti-money laundering implementation, the data cube 310 includes a combination of both clearing and debit transactions. In at least one embodiment, a new network field is added to the data cube to indicate whether the transaction is a clearing or debit transaction. Another field is added to indicate whether or not the party is a CGI, where CGI represent large government and institutional banks. This data cube 310 simplifies having to analyze multiple tables where data fields may have different column names. In some embodiments, different tables may have different names for the same entity, even including slight variations, which may cause problems in querying the tables. In some situations, in the databases 305, there may be up to four different names for the same party from different tables, based on how the party was set-up in the table.

In the exemplary embodiment, a plurality of rules 315 and elements 320 are stored in one or more databases 220 or 305. In the dynamic rule query system, the DAX queries 325 are configured to have a plurality of fields or elements 320 which are set-up based upon the needs of the user and how the data cube is set-up. In the exemplary embodiment, the multiple element 320 configuration of the data cube 310 and DAX queries 325 allows for users with user computer devices 205 to update DAX queries 325 by changing one or more elements 320 without having to significantly reprogram the dynamic rule query system 200 since the options are based on the configuration and build of the data cube 310.

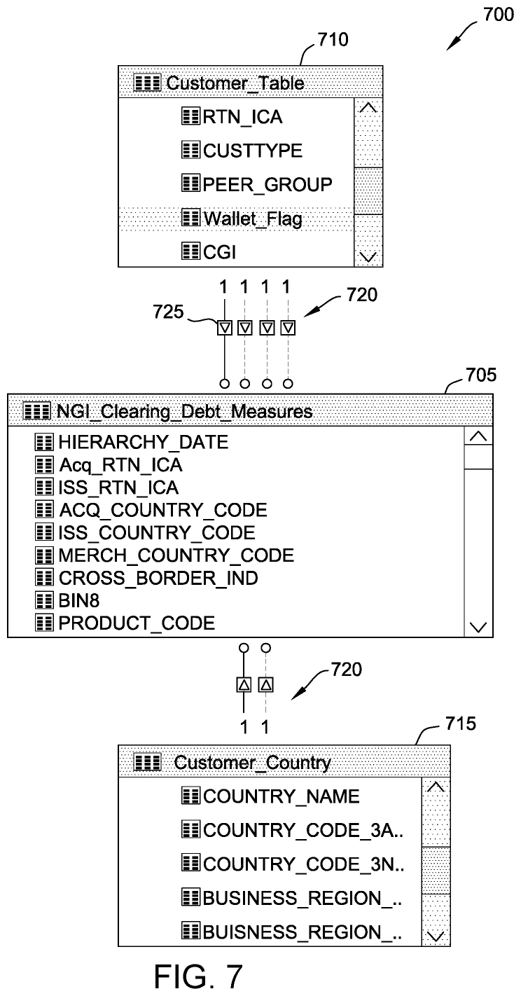

In the anti-money laundering implementation, the data cube 310 containing all of the transactions has a plurality of joins 720 with a customer table 710 (both shown in FIG. 7). While normal queries would support a single join, the dynamic rule query system 200 uses DAX (data analysis expressions) queries 325. Data Analysis Expressions (DAX) is a formula expression language. DAX formulas include functions, operators, and values to perform advanced calculations and queries on data in related tables and columns in tabular data models. The use of DAX queries 325 allows for the user to define one or more secondary joins. When executed, the DAX query 325 may use the different relationships. For example, the primary join 725 between the data cube 705 (both shown in FIG. 7) and the customer table 710 could be for the issuing customer. The secondary joins could then be the acquiring customer, the digital wallet, and/or the payment facilitator. The same DAX query 325 could be generated for each of the four customer types with only the customer type changing between the queries 325.

The DAX query 325 includes rules 315 and elements 320 selected by the user via the user computer device 205. The user computer device 205 and DRQ server 210 allow the user to configure the rules 315 to exactly manipulate the data in the data cube 310 based on the results 330 that the user is looking for. A rule 315 can be configured to be built over calculations. For example, a rule 315 could include filtering the data, then filtering down the results, then removing part of the filter, then do a separate calculation on those results and then to a comparison. Based on the configuration of the data cube 310, the DAX query 325 allows for a plurality of filters that can be dynamically added and removed. In the exemplary embodiment, the rules 315 include a plurality of predefined rules 315 that the user may select from in different combinations. In at least one embodiment, each rule 315 includes a listing of the different table columns that the rule 315 summarizes.

The elements 320 are also selectable by the user via the user computer device 205. The elements 320 include one or more fields that the DAX query 325 may manipulate, retrieve, and/or filter on. In the anti-money laundering implementation, there are three elements 320 that make up a DAX query 325 in addition to the rules 315. The rules 315 are a combination of filters, comparisons, and calculations that are performed on the transactions. In at least one embodiment, the rule is configured to trigger one or more alerts 330 based on the results. The first element 320 is the network, either clearing or debit. The second element 320 is the customer type, one of the four of issuing customer, acquiring customer, the digital wallet, and/or the payment facilitator. The third element 320 is the permutation of transaction type. Examples of this include, but are not limited to, ATM, prepaid card, ATM prepaid, card not present, POS e-commerce, and/or e-commerce. The DAX query 325 may be set-up for one or more of each of the second through fourth elements.

In at least one embodiment, the combinations of elements and rules can provide a large plurality of DAX queries 325 that can be executed. In one embodiment, there may be 496 different DAX queries 325 that can be run on a single data cube. The DAX queries 325 are configured to execute quickly on the data cube 310 and are capable of analyzing billions of transactions. For example, in the anti-money laundering implementation, the DAX queries 325 are executed over three months' worth of transaction data.

In the exemplary embodiment, the DAX query 325 pulls the data in, aggregates it, performs all of the calculations and filtering in the rule 315, and then determines if there is an alert 330 based on the results 330. The alert 330 may be based on one or more thresholds being exceeded.

While the above describes the dynamic rule query system 200 being used for an anti-money laundering implementation, one having skill in the art would understand that other implementations may be used as well. For a non-limited example, the dynamic rule query system 200 may be used to analyze cryptographic transactions and/or analyze transactions to determine one or more other trends and/or patterns.

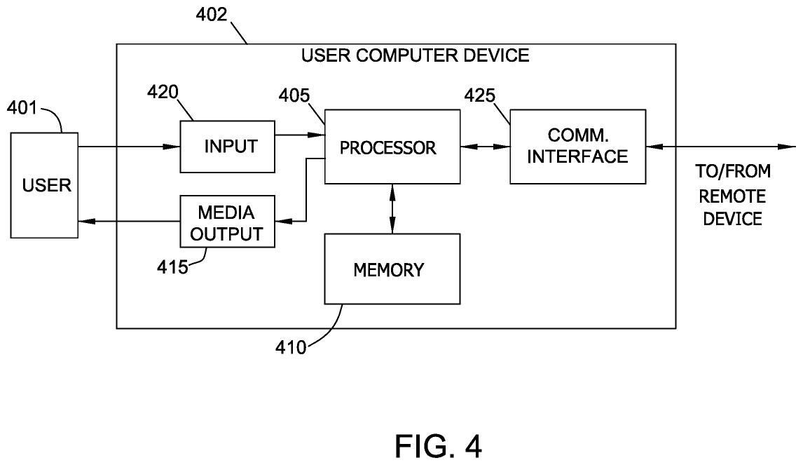

FIG. 4 illustrates an example configuration of a user computing device 402. User computing device 402 may include, but is not limited to, user computer device 205 (shown in FIG. 2). User computing device 402 includes a processor 405 for executing instructions. In some embodiments, executable instructions are stored in a memory area 410. Processor 405 may include one or more processing units (e.g., in a multi-core configuration). Memory area 410 is any device allowing information such as executable instructions and/or other data to be stored and retrieved. Memory area 410 may include one or more computer-readable media.

User computing device 402 also includes at least one media output component 415 for presenting information to a user 400. Media output component 415 is any component capable of conveying information to user 400. In some embodiments, media output component 415 includes an output adapter such as a video adapter and/or an audio adapter. An output adapter is operatively coupled to processor 405 and operatively couplable to an output device such as a display device (e.g., a cathode ray tube (CRT), liquid crystal display (LCD), light emitting diode (LED) display, or “electronic ink” display) or an audio output device (e.g., a speaker or headphones).

In some embodiments, user computing device 402 includes an input device 420 for receiving input from user 401. Input device 420 may include, for example, a keyboard, a pointing device, a mouse, a stylus, a touch sensitive panel (e.g., a touch pad or a touch screen), a camera, a gyroscope, an accelerometer, a position detector, and/or an audio input device. A single component such as a touch screen may function as both an output device of media output component 415 and input device 420.

User computing device 402 may also include a communication interface 425, which is communicatively couplable to a remote device such as DRQ server 210 (shown in FIG. 2). Communication interface 425 may include, for example, a wired or wireless network adapter or a wireless data transceiver for use with a mobile phone network (e.g., Global System for Mobile communications (GSM), 3G, 4G or Bluetooth) or other mobile data network (e.g., Worldwide Interoperability for Microwave Access (WIMAX)).

Stored in memory area 410 are, for example, computer readable instructions for providing a user interface to user 401 via media output component 415 and, optionally, receiving and processing input from input device 420. A user interface may include, among other possibilities, a web browser and/or a client application. Web browsers enable users, such as user 401, to display and interact with media and other information typically embedded on a web page or a website from DRQ server 210. A client application allows user 401 to interact with, for example, message traffic and/or transaction reports. For example, instructions may be stored by a cloud service, and the output of the execution of the instructions sent to the media output component 415.

Processor 405 executes computer-executable instructions for implementing aspects of the disclosure. In some embodiments, the processor 405 is transformed into a special purpose microprocessor by executing computer-executable instructions or by otherwise being programmed.

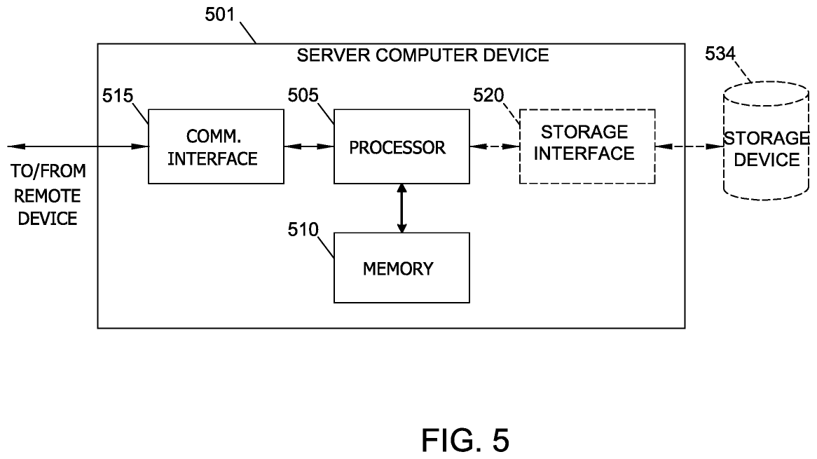

FIG. 5 illustrates an example configuration of a server system 501 such as DRQ platform 34 (shown in FIG. 1), in accordance with one example embodiment of the present disclosure. Server system 501 may also include, but is not limited to, DRQ platform 34 (shown in FIG. 1), DRQ server 210, and database server 215 (both shown in FIG. 2). In the example embodiment, server system 501 determines and analyzes patterns in transactions, as described herein.

Server system 501 includes a processor 505 for executing instructions. Instructions may be stored in a memory area 510, for example. Processor 505 may include one or more processing units (e.g., in a multi-core configuration) for executing instructions. The instructions may be executed within a variety of different operating systems on the server system 501, such as UNIX, LINUX, Microsoft Windows®, etc. It should also be appreciated that upon initiation of a computer-based method, various instructions may be executed during initialization. Some operations may be required in order to perform one or more processes described herein, while other operations may be more general and/or specific to a particular programming language (e.g., C, C#, C++, Java, or other suitable programming languages, etc.).

Processor 505 is operatively coupled to a communication interface 515 such that server system 501 is capable of communicating with a remote device such as a user system or another server system 501. For example, communication interface 515 may receive requests from a user computer device 205 via the Internet, as illustrated in FIG. 2.

Processor 505 may also be operatively coupled to a storage device 534. Storage device 534 is any computer-operated hardware suitable for storing and/or retrieving data. In some embodiments, storage device 534 is integrated in server system 501. For example, server system 501 may include one or more hard disk drives as storage device 534. In other embodiments, storage device 534 is external to server system 501 and may be accessed by a plurality of server systems 501. For example, storage device 534 may include multiple storage units such as hard disks or solid state disks in a redundant array of inexpensive disks (RAID) configuration. Storage device 534 may include a storage area network (SAN) and/or a network attached storage (NAS) system.

In some embodiments, processor 505 is operatively coupled to storage device 534 via a storage interface 520. Storage interface 520 is any component capable of providing processor 505 with access to storage device 534. Storage interface 520 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 505 with access to storage device 534.

Memory area 510 may include, but are not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are examples only, and are thus not limiting as to the types of memory usable for storage of a computer program.

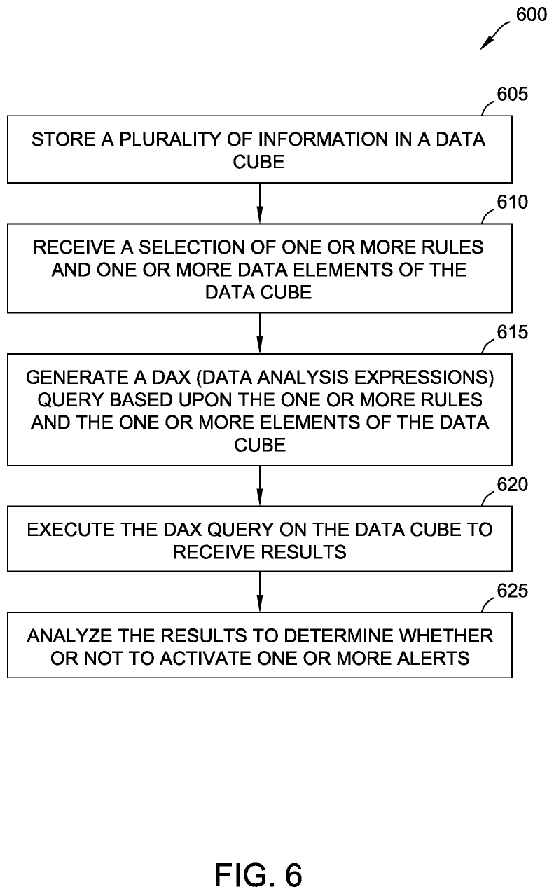

FIG. 6 is a flow diagram of an example process 600 for dynamic rule queries using the DRQ system 200 (shown in FIG. 2). In the exemplary embodiment, process 600 is performed by the DRQ server 210 (shown in FIG. 2).

In the exemplary embodiment, the DRQ server 210 stores 605 a plurality of information in a data cube 310 (shown in FIG. 3). In at least one embodiment, the plurality of information includes a concatenation of one or more databases 305 (shown in FIG. 3) and/or tables.

In the exemplary embodiment, the DRQ server 210 receives 610 a selection of one or more rules 315 and one or more data elements 320 (both shown in FIG. 3) of the data cube 310. In at least one embodiment, the one or more data elements 320 are selected from a plurality of data elements 320 of the data cube 310. In at least one additional embodiment, the one or more rules 315 are selected from a plurality of rules 315. In the exemplary embodiment, the DRQ server 210 receives 610 the selection from a user computer device 205 (shown in FIG. 2). The user computer device 205 receives the plurality of rules 315 and the plurality of data elements 320 and displays the two pluralities to the user. Then the user computer device 205 receives the selections of the user and forwards those selections to the DRQ server 210.

In the exemplary embodiment, the DRQ server 210 generates 615 a DAX (data analysis expressions) query 325 (shown in FIG. 3) based upon the one or more rules 315 and the one or more elements 320 of the data cube 310.

In the exemplary embodiment, the DRQ server 210 executes 620 the DAX query 325 on the data cube 310 to receive results 330 (shown in FIG. 3). The DAX query 325 is configured to determine if one or more patterns are present in the data in the data cube 310.

In the exemplary embodiment, the DRQ server 210 analyzes 625 the results 330 to determine whether or not to activate one or more alerts. In at least one embodiment, the DAX query 325 analyzes the results 330 to determine whether or not to active the one or more alerts. Then the DRQ server 210 forwards the results 330 and/or the alerts to the user computer device 205 that the selections were received from. In additional embodiment, the DRQ server 210 also forwards the results 330 and/or the alerts to other user computer devices 205, as well. In at least some embodiments, the one or more alerts are activated when the results 330 exceed one or more predetermined thresholds.

In the anti-money laundering implementation, the data cube 310 includes a plurality of payment transactions including both credit and debit transactions. The DAX query 325 is configured to determine if one or more patterns are present in the data in the data cube 310. In some embodiments, the one or more patterns indicate the potential presence of money laundering activity. The potential presence of money laundering activity is at an issuer bank 30 (shown in FIG. 1) associated with a plurality of transactions in the data cube 310.

While the above describes the dynamic rule query system 200 being used for an anti-money laundering implementation, one having skill in the art would understand that other implementations may be used as well. For a non-limited example, the dynamic rule query system 200 may be used to analyze cryptographic transactions and/or analyze transactions to determine one or more other trends and/or patterns.

FIG. 7 illustrates a sample data cube system 700 as shown in FIG. 3. The data cube system 700 includes a data cube 705, where the data cube 700 is similar to data cube 310 (shown in FIG. 3). In at least one embodiment, data cube 705 includes a plurality of payment transactions including both debit and credit transactions.

The data cube 705 is connected to two tables 710 and 715. The first table 710 is a customer table 710 with information about the customers (issuers, acquirers, digital wallets, and/or the payment facilitators). The customer table 710 have multiple joins 720 to the data cube 705. These joins 720 include one primary join 725 and a plurality of secondary joins. In at least one embodiment, the primary join 725 is associate with the issuer 30. The secondary joins are associated with the other customer types.

The second table 715 is a customer country table 715 and includes information about the countries associated with different customers. The customer country table 715 include a plurality of joins to the data cube 705 as well.

While the above describes the data cube system 700 being used for an anti-money laundering implementation, one having skill in the art would understand that other implementations may be used as well. For a non-limited example, the data cube system 700 may be used to analyze cryptographic transactions and/or analyze transactions to determine one or more other trends and/or patterns.

As used herein, the term “non-transitory computer-readable media” is intended to be representative of any tangible computer-based device implemented in any method or technology for short-term and long-term storage of information, such as, computer-readable instructions, data structures, program modules and sub-modules, or other data in any device. Therefore, the methods described herein may be encoded as executable instructions embodied in a tangible, non-transitory, computer readable medium, including, without limitation, a storage device and/or a memory device. Such instructions, when executed by a processor, cause the processor to perform at least a portion of the methods described herein. Moreover, as used herein, the term “non-transitory computer-readable media” includes all tangible, computer-readable media, including, without limitation, non-transitory computer storage devices, including, without limitation, volatile and nonvolatile media, and removable and non-removable media such as a firmware, physical and virtual storage, CD-ROMs, DVDs, and any other digital source such as a network or the Internet, as well as yet to be developed digital means, with the sole exception being a transitory, propagating signal.

This written description uses examples to disclose the disclosure, including the best mode, and also to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A dynamic rule query system comprising:
a memory device; and
at least one processor coupled to the memory device, the at least one processor programmed to:
store a plurality of information in a data cube;
receive a selection of one or more rules and one or more data elements of the data cube;
generate a DAX (data analysis expressions) query based upon the one or more rules and the one or more elements of the data cube;
execute the DAX query on the data cube to receive results; and
analyze the results to determine whether or not to activate one or more alerts.

2. The system of claim 1, wherein the one or more data elements are selected from a plurality of data elements of the data cube.

3. The system of claim 1, wherein the one or more rules are selected from a plurality of rules.

4. The system of claim 1, wherein the data cube includes a concatenation of data from a plurality of tables.

5. The system of claim 1, wherein the DAX query analyzes the results to determine whether or not to active the one or more alerts.

6. The system of claim 1, wherein the one or more alerts are activated when the results exceed one or more predetermined thresholds.

7. The system of claim 1, wherein the data cube includes a plurality of payment transactions including both credit and debit transactions.

8. The system of claim 1, wherein the DAX query is configured to determine if one or more patterns are present in the data in the data cube.

9. The system of claim 8, wherein the one or more patterns indicate the potential presence of money laundering activity.

10. The system of claim 9, wherein the potential presence of money laundering activity is at an issuer bank associated with a plurality of transactions in the data cube.

11. A computer-implemented method for dynamic rules queries, the method implemented on a computing device comprising a memory device coupled to at least one processor, and the method comprises:
storing a plurality of information in a data cube;
receiving a selection of one or more rules and one or more data elements of the data cube;
generating a DAX (data analysis expressions) query based upon the one or more rules and the one or more elements of the data cube;
executing the DAX query on the data cube to receive results; and
analyzing the results to determine whether or not to activate one or more alerts.

12. The method of claim 11, wherein the one or more data elements are selected from a plurality of data elements of the data cube.

13. The method of claim 11, wherein the one or more rules are selected from a plurality of rules.

14. The method of claim 11, wherein the data cube includes a concatenation of data from a plurality of tables.

15. The method of claim 11, wherein the DAX query analyzes the results to determine whether or not to active the one or more alerts.

16. The method of claim 11, wherein the one or more alerts are activated when the results exceed one or more predetermined thresholds.

17. The method of claim 11, wherein the data cube includes a plurality of payment transactions including both credit and debit transactions.

18. The method of claim 11, wherein the DAX query is configured to determine if one or more patterns are present in the data in the data cube.

19. The method of claim 18, wherein the one or more patterns indicate the potential presence of money laundering activity, and wherein the potential presence of money laundering activity is at an issuer bank associated with a plurality of transactions in the data cube.

20. At least one non-transitory computer-readable storage media having computer-executable instructions embodied thereon for authenticating an online user, wherein when executed by at least one processor, the computer-executable instructions cause the at least one processor to:
store a plurality of information in a data cube;
receive a selection of one or more rules and one or more data elements of the data cube;
generate a DAX (data analysis expressions) query based upon the one or more rules and the one or more elements of the data cube;
execute the DAX query on the data cube to receive results; and
analyze the results to determine whether or not to activate one or more alerts.
